(19) United States
(12) Patent Application Publication
(10) Pub. No.: US 2010/0121600 A1
(43) Pub. Date: May 13, 2010

(54) Method and Device For Checking A Pressure Sensor Of A Fuel Injector System

(76) Inventor: Rene Zieher, Edingen-Neckarhausen (DE)

Correspondence Address: KENYON & KENYON LLP, ONE BROADWAY, NEW YORK, NY, 10004, US

(21) Appl. No.: 12/615,440

(22) Filed: Nov. 10, 2009

(30) Foreign Application Priority Data
Nov. 10, 2008 (DE) 102008043592.9

(51) Int. Cl. G01L 27/00; G01M 15/04

(52) U.S. Cl. 702/98; 73/114.51

(57) ABSTRACT

A method for checking a pressure sensor of a fuel injection system, especially of a motor vehicle, the fuel injector system having a pressure reservoir to which the pressure sensor and an injector are assigned; in the method, a fuel quantity being injected under a pressure by the injector, wherein a pressure difference, which is created by a sudden pressure drop caused by the injection process, is ascertained as a function of the pressure and the fuel quantity.

### FIELD OF THE INVENTION

The present invention relates to a method for checking a pressure sensor of a fuel injector system, particularly of a motor vehicle, the fuel injector system having a pressure reservoir to which the pressure sensor and an injector are assigned; in the method, a fuel quantity being injected under a pressure by the injector. In addition, the present invention relates to a device for checking a pressure sensor of a fuel injector system, particularly of a motor vehicle, the fuel injector system having a pressure reservoir to which the pressure sensor and an injector are assigned; a fuel quantity being able to be injected under a pressure by the injector.

### BACKGROUND INFORMATION

Current legislation requires the monitoring of components of the injection system. This also includes the pressure sensor. The latter has to be monitored with respect to its signal.

One possible way in which such a pressure sensor has to be monitored has been described in the related art. German Patent No. DE 10 2004 028 891 describes a method for operating an internal combustion engine, particularly of a motor vehicle, in which the pressure sensor measures the pressure acting on the fuel to be injected, and inaccuracies and deviations of the measured pressure from the actual pressure are ascertained and corrected. In this instance, the fuel is injected under an actual pressure by an injector, and the pressure is measured by the pressure sensor. A differential signal is ascertained which represents the deviation of the pressure measured by the pressure sensor from the actual pressure. Based on the differential signal, a correction may be undertaken of the signal measured by the pressure sensor.

### SUMMARY OF THE INVENTION

The present invention is based on the object of improving the detection of inaccuracies and malfunctions of the pressure sensor. No other components, particularly no additional pressure sensor, are to be used for verifying the pressure measured by the pressure sensor, in this context.

In order to attain this object, starting from a method of the type named at the outset, it is provided that the pressure difference that is created by a sudden pressure drop due to the injection process be ascertained as a function of the pressure and the fuel quantity. It has been recognized, according to the present invention, that the actual pressure curve is able to be observed and monitored, based on the known injected fuel quantity and the known steady-state adjusted pressure.

According to one advantageous specific embodiment of the present invention, it is provided that the pressure difference is compared to a pressure difference recorded by measuring the pressure, particularly by a specific sensing of the pressure, and that the pressure sensor is assessed as a function of this. Consequently, a comparison of the two pressure differences is sufficient for ascertaining a correct or an erroneous functioning, only a single pressure sensor having to be used to measure the pressure.

As a further attainment of the object of the present invention, the device according to the present invention has means for ascertaining a pressure difference, that is created by a sudden pressure drop, caused by the injection process, as a function of the pressure and the fuel quantity. Thus, the sudden pressure drop is able to be ascertained using only two factors, the steady-state adjusted pressure and the injected fuel quantity.

According to one advantageous specific embodiment of the present invention, it is provided that the device have means for comparing the pressure difference to a pressure difference recorded by measuring the pressure, particularly by a specific sensing of the pressure, and have means for assessing the pressure sensor in dependence upon the comparison. According to one preferred specific embodiment of the present invention, it is provided that the means include an electric control device. The means preferably include a computer program which is executable on a computer, particularly on a processor. A computer program is able to be changed and replaced in a simple manner.

### BRIEF DESCRIPTION OF THE DRAWINGS

FIG. 1 shows a schematic block diagram of an exemplary embodiment of an internal combustion engine for a motor vehicle.

FIG. 2a shows the characteristics curve of an injection process.

FIG. 2b shows the rail pressure curve, particularly during the injection process.

FIG. 3 shows a schematic block diagram for ascertaining a difference signal.

### DETAILED DESCRIPTION

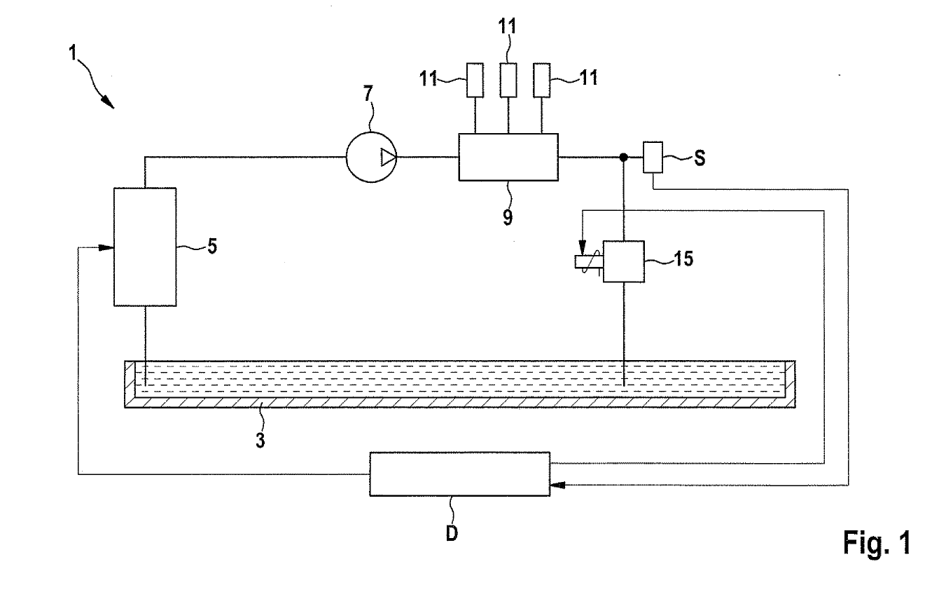

A fuel delivery system 1 of an internal combustion engine is shown in a simplified manner in FIG. 1. Fuel delivery system 1 is customarily also referred to as a common-rail system and is suitable for the direct injection of fuel, under high pressure, into the combustion chambers of the internal combustion engine. In the process, the fuel travels from a fuel tank 3 to a high pressure pump 7 via various auxiliary devices 5 that are controlled by a control device D. High-pressure pump 7 is connected to a fuel accumulator 9, which is frequently also referred to as a rail. Fuel accumulator 9 is in contact with injectors 11 via fuel lines. The fuel is injected into the combustion chambers of the internal combustion engine via these injectors 11. A pressure regulating valve 15 is connected to fuel accumulator 9, and is coupled on its output side with fuel tank 3.

During the injection of fuel into the combustion chamber via injectors 11, a fuel removal from fuel accumulator 9 takes place, which results in the reduction of the pressure in fuel accumulator 9.

In order to be able to influence the fuel quantity that is to be injected, it is necessary to regulate and/or control the pressure in fuel accumulator 9. In order to do this, the pressure in fuel accumulator 9 is measured using a pressure sensor S, so as to control pressure regulating valve 15 appropriately by control device D, according to the measured data.

This presupposes correct functioning of pressure sensor S. Inaccuracies, ageing processes or malfunctions of pressure sensor S may lead to the fuel quantity injected by injector 11 not being correct, or no fuel being injected at all. Deviations of the actual pressure from the measured pressure must therefore be ascertained and corrected.

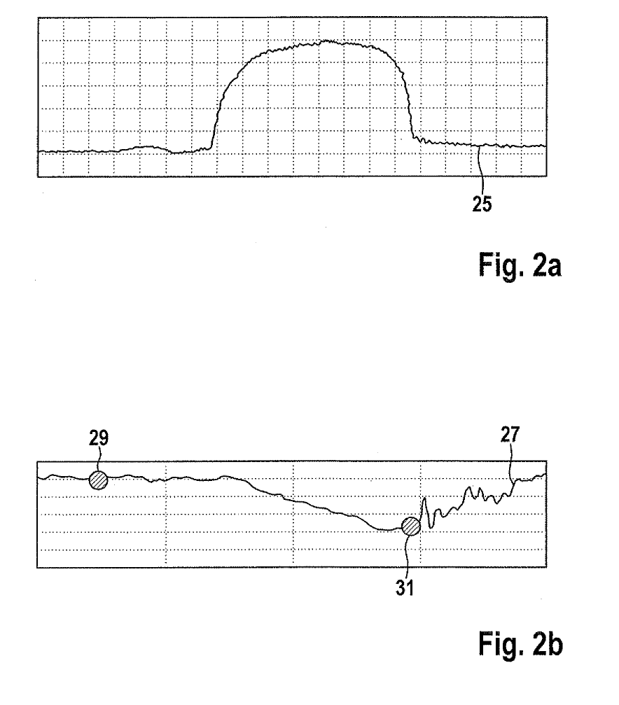

A characteristics curve 25 shown in FIG. 2a shows an injection process in an exemplary manner. The ordinate reflects the opening state of injector 11, in this instance, and with that the injection rate, and the abscissa shows the time lapse. A characteristics curve 27 shown in FIG. 2b shows the pressure curve in fuel accumulator 9 which comes about simultaneously to the injection process shown in FIG. 2a. The ordinate shows the current pressure in fuel accumulator 9, in this context, and the abscissa shows the time. FIG. 2b also shows two measuring times 29 and 31, of which each represents an observation time at which the pressure, measured in clocked fashion, is recorded. Measuring time 29 represents the recording of steady-state pressure p1 before the beginning of the injection process, and measuring time 31 represents measured pressure p1 after the injection. One may see, with the aid of characteristics curve 27 in FIG. 2b, that pressure p1 decreases within the scope of the injection process shown in FIG. 2a.

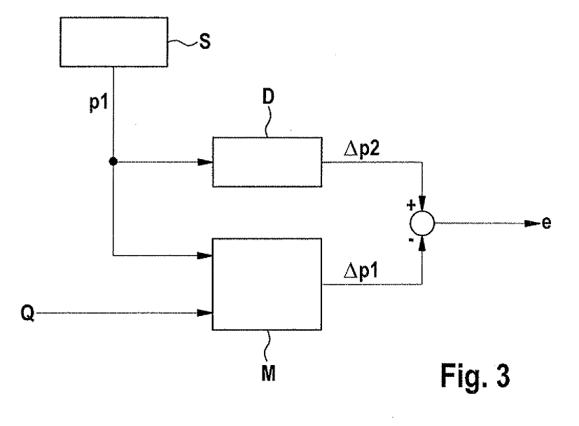

FIG. 3 shows a block diagram of the attainment of the object according to the present invention, for checking the signal of pressure sensor S. Pressure p1 recorded by pressure sensor S in fuel accumulator 9 is measured continuously in a clocked manner, and the measuring signal is supplied to control device D. From the pressure difference in the fuel accumulator at the beginning and the end of the injection process, control device D ascertains the differential value which corresponds to a real pressure drop Δp2. In addition, pressure signal p1 is supplied to a modeling unit M, together with a signal Q which reflects the injection quantity. Based on pressure p1 adjusted in a steady-state manner at the beginning of the injection process, and injection quantity Q, modeling unit M ascertains a setpoint pressure difference Δp1, using a calculated simulation of the injection process, which corresponds to real pressure drop Δp2 in fuel accumulator 9, based on such an injection process. From the two pressure differences Δp1 and Δp2, a differential signal e is produced, which gives information as to whether, and to what extent a deviation of the real pressure difference Δp2, measured by sensing, from setpoint pressure difference Δp1 ascertained using modeling M, is present. One may conclude that an error has occurred, for instance, based on an appropriately high deviation.

The present invention thus makes it possible to observe and monitor the pressure curve, based on a known steady-state adjusted injection pressure and a known injection quantity, whereupon, in particular, no additional pressure sensor is required and no additional functional variables are required for checking in conformance with legal requirements.

What is claimed is:

1. A method for checking a pressure sensor of a fuel injection system of a motor vehicle, the fuel injection system having a pressure reservoir to which the pressure sensor and an injector are assigned, the method comprising:
injecting a fuel quantity under a pressure by the injector; and
ascertaining a pressure difference, which is created by a sudden pressure drop caused by an injection process, as a function of the pressure and the fuel quantity.

2. The method according to claim 1, further comprising:
comparing the pressure difference to another pressure difference that is recorded by measuring the pressure, by sensing the pressure; and
assessing the pressure sensor as a function of the comparison.

3. A device for checking a pressure sensor of a fuel injection system of a motor vehicle, the fuel injection system having a pressure reservoir to which the pressure sensor and an injector are assigned, a fuel quantity being able to be injected under a pressure by the injector, the device comprising:
means for ascertaining a pressure difference, which is created by a sudden pressure drop caused by an injection process, as a function of the pressure and the fuel quantity.

4. The device according to claim 3, further comprising:
means for comparing the pressure difference to another pressure difference that is recorded by measuring the pressure, by sensing the pressure; and
means for assessing the pressure sensor as a function of the comparison.

5. The device according to claim 3, wherein the means for ascertaining includes an electric control device.

6. The device according to claim 3, wherein the means for ascertaining includes a processor for executing a computer program.
